(19) United States
(12) Patent Application Publication
(10) Pub. No.: US 2016/0179165 A1
(43) Pub. Date: Jun. 23, 2016

(54) SENSOR SYSTEM INCLUDING WIRELESS SENSOR

(71) Applicant: EATON CORPORATION, Cleveland, OH (US)

(72) Inventor: DARRON KIRBY LACEY, FAYETTEVILLE, GA (US)

(73) Assignee: EATON CORPORATION, CLEVELAND, OH (US)

(21) Appl. No.: 14/574,802

(22) Filed: Dec. 18, 2014

(51) Int. Cl. G06F 1/32

(52) U.S. Cl. CPC G06F 1/3206; G06F 1/3234

(57) ABSTRACT

A sensor system includes a sensor including a sensing unit structured to sense a condition, a wireless transmitter structured to output a wireless signal in response to the sensing unit sensing the condition, and a battery structured to provide power to operate the sensing unit and the wireless transmitter. The sensor system further includes a control unit including a wireless receiver structured to receive the wireless signal from the sensor. The control unit is structured to electrically connect a power source and an electric device in response to receiving the wireless signal from the sensor.

### BACKGROUND

1. Field

The disclosed concept relates generally to sensor systems, and in particular, to occupancy sensor systems.

2. Background Information

Sensors are used to sense a variety of conditions such as occupancy, temperature, light level, moisture/humidity, etc. When used in a building, sensors are typically wired to the building's electrical system.

Referring to FIG. 1, a schematic diagram of a conventional occupancy sensor system used in a building is shown. In FIG. 1, a light switch fixture 2 includes a light switch 4 and an occupancy sensor 6. The occupancy sensor 6 is structured to sense motion in order to determine whether a person is occupying a room. The light switch 4 and the occupancy sensor 6 are electrically wired to a light 8 such that the light switch 4 or the occupancy sensor 6 can turn on the light 8. That is, the light 8 can be turned on by actuating the light switch 4 or by the occupancy sensor 6 sensing motion.

The occupancy sensor 6, being located in the light switch fixture 2, may not be located in an optimal area of a room for detecting occupancy of the room. For instance, the light switch fixture 2 may be located in an area of the room, such as a nook or hallway, where it cannot detect people moving in the room. Moreover, even if the occupancy sensor 6 were moved out of the light switch fixture 2, electrical wiring would need to be installed to support the new location of the occupancy sensor 6, which can significantly add to the cost of installing the occupancy sensor 6.

The occupancy sensor 6 of FIG. 1 also corresponds to the single light 8. If additional lights on different electrical circuits are to be controlled based on occupancy of the room, additional occupancy sensors would need to be installed. Additionally, if different types of devices such as, for example, radios and air conditioning, are to be controlled based on occupancy of the room, additional occupancy sensors would need to be installed. Thus, the addition of devices to be controlled based on occupancy adds cost to the system.

There is room for improvement in sensors such as occupancy sensors.

### SUMMARY

These needs and others are met by embodiments of the disclosed concept in which a sensor system includes a sensor including a wireless transmitter, a sensing unit, and a battery, and the sensor is structured to output a wireless signal in response to the sensing unit sensing a condition.

In accordance with one aspect of the disclosed concept, a sensor system comprises: a sensor including: a sensing unit structured to sense a condition; a wireless transmitter structured to output a wireless signal in response to the sensing unit sensing the condition; and a battery structured to provide power to operate the sensing unit and the wireless transmitter; and a control unit including a wireless receiver structured to receive the wireless signal from the sensor, wherein the control unit is structured to electrically connect a power source and an electric device in response to receiving the wireless signal from the sensor.

### BRIEF DESCRIPTION OF THE DRAWINGS

A full understanding of the disclosed concept can be gained from the following description of the preferred embodiments when read in conjunction with the accompanying drawings in which:

FIG. 1 is schematic diagram of a conventional occupancy sensor system;

FIG. 2 is a schematic diagram of a sensor system in accordance with an example embodiment of the disclosed concept;

FIG. 3 is a schematic diagram in block form of the sensor system of FIG. 2 shown in more detail;

FIG. 4 is a schematic diagram in block form of a sensor system in accordance with another example embodiment of the disclosed concept;

FIG. 5 is a schematic diagram in block form of a sensor system in accordance with another example embodiment of the disclosed concept; and

FIG. 6 is a schematic diagram in block form of a sensor system in accordance with another example embodiment of the disclosed concept.

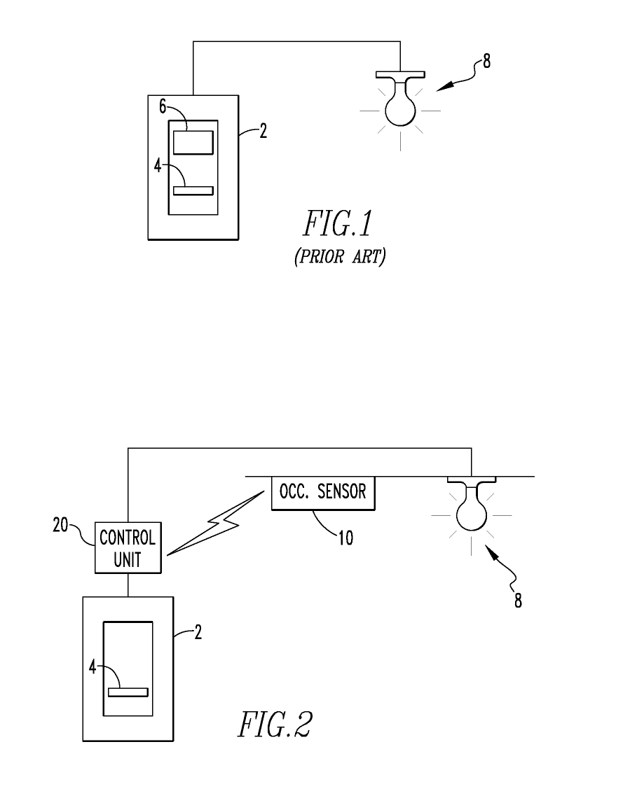

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

FIG. 2 is a schematic diagram of a sensor system in accordance with an example embodiment of the disclosed concept. FIG. 3 is a schematic diagram in block form of the sensor system of FIG. 2 shown in more detail. The sensor system includes an occupancy sensor 10, a control unit 20, and a light 8. Although a light 8 is shown in FIGS. 2 and 3, it is contemplated that other electric devices (e.g., without limitation, a radio, air conditioning, etc.) may be used in place of or in addition to the light without departing from the scope of the disclosed concept.

The occupancy sensor 10 is structured to sense a condition, such as motion in a room, to determine whether the room is occupied. The occupancy sensor 10 wirelessly communicates the occupancy status of the room to the control unit 20. That is, the occupancy sensor 10 outputs a wireless signal to the control unit 20 in response to detecting motion. In response to receiving the wireless signal from the occupancy sensor 10, the control unit 20 turns on the light 8.

A light switch fixture 2 and a light switch 4 are shown in FIG. 2. In addition to being controlled by the occupancy sensor 10 and control unit 20, the light 8 may also be controlled by actuating the light switch 4. However, it is contemplated that the light switch fixture 2 and the light switch 4 may be omitted, and the light 8 may be controlled via only the occupancy sensor 10 and the control unit 20.

Referring to FIG. 2, the occupancy sensor 10 includes a wireless transmitter 12, a battery 14, and a sensing unit 16, and the control unit 20 includes a wireless receiver 22 and a switching circuitry 24. The occupancy sensor 10 outputs the wireless signal via the wireless transmitter 12 and the control unit 20 receives the wireless signal via the wireless receiver 22. It is contemplated that the occupancy sensor 10 and the control unit 20 may communicate using any suitable wireless communication protocol such as, without limitation, Bluetooth®, Wi-Fi, Z-Wave, or any other suitable wireless communication protocol.

The battery 14 in the occupancy sensor 10 provides power for operating the occupancy sensor 10. In more detail, the battery 14 provides power to the wireless transmitter 12 to transmit the wireless signal. The battery 14 also provides power to operate the sensing unit 16. By providing the battery 14 on the occupancy sensor 10, the occupancy sensor 10 does not need to be electrically wired to a power source or the light 8.

The sensing unit 16 of the occupancy sensor 10 senses motion in the room. Any suitable circuitry for sensing motion may be employed in the sensing unit 16 without departing from the scope of the disclosed concept.

The switching circuitry 24 in the control unit 20 is structured to electrically connect and electrically disconnect the light 8 and a power source 30. The switching circuitry 24 electrically connects the light 8 to the power source 30, which turns on the light 8, in response to the control unit 20 receiving the wireless signal from the occupancy sensor 10. The switching circuitry 24 may electrically disconnect the light 8 from the power source 30, which turns off the light 8, in response to a predetermined condition such as, without limitation, a predetermined period of time passing without the occupancy sensor 10 sensing motion in the room (i.e., the control unit 20 does not receive the wireless signal for the predetermined period of time). The switching circuit 24 may include any suitable type of electrical switches (e.g., without limitation, transistors, electrically controlled relays, etc.) to electrically connect and electrically disconnect the light 8 and the power source 30.

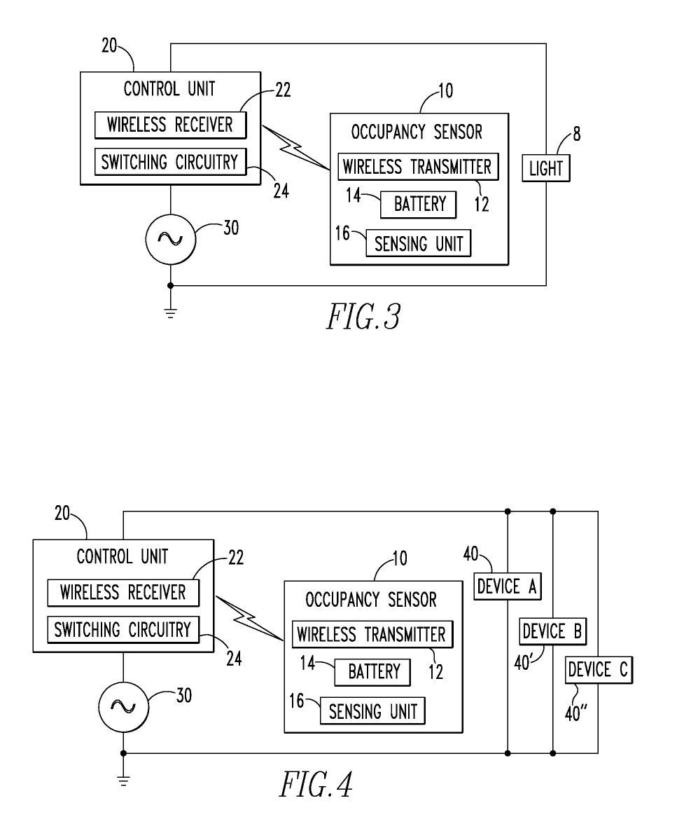

Referring to FIG. 4, a schematic diagram in block form of a sensor system in accordance with another example embodiment of the disclosed concept is shown. The sensor system of FIG. 4 includes the occupancy sensor 10 and control unit 20, similar to the sensor systems of FIGS. 2 and 3. However, in the sensor system of FIG. 4, the control unit 20 is electrically connected to device A 40, device B 40′, and device C 40″, rather than the light 8. Devices A, B, and C 40,40′,40″ are any type of electrical device (e.g., without limitation, light, radio, air conditioning, etc.) that is to be controlled based on occupancy of the room. When the occupancy sensor 10 detects occupancy of the room and outputs the wireless signal, the control unit 20 turns on devices A, B, and C 40,40′,40″. While devices A, B, and C 40,40′,40″ are shown electrically connected in parallel with each other, it is contemplated that devices A, B, and C 40,40′,40″ may be connected in series, in a combination of series and parallel connections, or in any other suitable electrical connection scheme. Additionally, while three devices are shown in FIG. 4, it is contemplated that any number of electrical devices may be controlled by the occupancy sensor 10 and control unit 20 without departing from the scope of the disclosed concept.

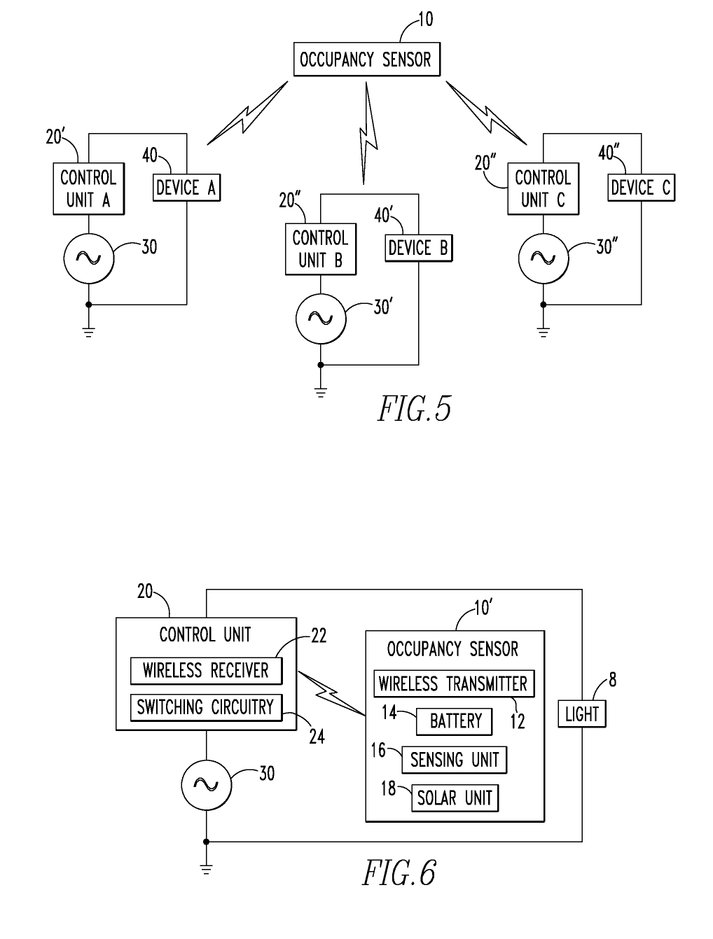

FIG. 5 is a schematic diagram in block form of a sensor system in accordance with another example embodiment of the disclosed concept. The sensor system of FIG. 4 includes the occupancy sensor 10 similar to the sensor systems of FIGS. 2 and 3. However, instead of including a single control unit, the sensor system of FIG. 5 includes control units A, B, and C 20′,20″,20′″. The control units A, B, and C 20′,20″,20′″ correspond to power sources 30,30′,30″ and devices A, B, and C 40,40′,40″, respectively. The control units A, B, and C 20′,20″,20′″ are structured to electrically connect their respective power source to their respective device in response to receiving the wireless signal from the occupancy sensor 10. In this manner, multiple devices that are not electrically wired together may be controlled from a single occupancy sensor.

FIG. 6 is a schematic diagram in block form of a sensor system in accordance with another example embodiment of the disclosed concept. The sensor system of FIG. 6 is similar to the sensor system of FIGS. 2 and 3. However, the sensor system of FIG. 6 includes an occupancy sensor 10′ that further includes a solar unit 18. The solar unit 18 is structured to harvest solar power and provide it to the battery 14. By including the solar unit 18, the time between battery replacements for the occupancy sensor 10′ can be greatly increased.

While the disclosed concept has been described with respect to occupancy sensors, it is contemplated that the disclosed concept may also be applied to other types of sensors. For example and without limitation, it is contemplated that the disclosed concept may be applied to temperature sensors, light level sensors, moisture/humidity sensors, etc. In more detail, the sensing unit 16 of the occupancy sensor 10 (see FIG. 3) may be replaced by the sensing unit of a different type of sensor (e.g., without limitation, a temperature sensing unit). It is also contemplated that the wireless signal output to the control unit 20 may carry information (e.g., without limitation, temperature information).

In the sensor systems described herein, the occupancy sensor (or other type of sensor) does not need to be electrically wired to the device it controls. This allows greater freedom in the placement of the occupancy sensor so that it can be placed in an optimal location for detecting occupancy of the room. Additionally, the occupancy sensor can correspond to multiple devices, whether they are electrically wired together or not.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A sensor system comprising:
a sensor including:
a sensing unit structured to sense a condition;
a wireless transmitter structured to output a wireless signal in response to the sensing unit sensing the condition; and
a battery structured to provide power to operate the sensing unit and the wireless transmitter; and
a control unit including a wireless receiver structured to receive the wireless signal from the sensor,
wherein the control unit is structured to electrically connect a power source and an electric device in response to receiving the wireless signal from the sensor.

2. The sensor system of claim 1, wherein the condition is motion in a room.

3. The sensor system of claim 1, wherein the electric device is a light.

4. The sensor system of claim 1, wherein the control unit further includes switching circuitry structured to electrically connect and electrically disconnect the power source and the electric device.

5. The sensor system of claim 4, wherein the switching circuitry includes at least one of a transistor and an electrically controlled relay.

6. The sensor system of claim 4, wherein the switching circuitry is structured to electrically disconnect the power source from the electric device in response to a predetermined period of time passing without the control unit receiving the wireless signal from the sensor.

7. The sensor system of claim 1, wherein the control unit is structured to electrically connect the power source to a plurality of electric devices in response to receiving the wireless signal from the sensor.

8. The sensor system of claim 1, further comprising:
a plurality of control units each including a wireless receiver structured to receive the wireless signal from the sensor,
wherein each of the plurality of control units are structured to electrically connect a corresponding power source to a corresponding electric device in response to receiving the wireless signal from the sensor.

9. The sensor system of claim 1, wherein the sensor is an occupancy sensor.

10. The sensor system of claim 1, wherein the sensor is one of a temperature sensor, a light level sensor, and moisture/humidity sensor.

11. The sensor system of claim 1, wherein the electric device is one of a radio and an air conditioner.

12. The sensor system of claim 1, wherein the sensor further includes a solar unit structured to harvest solar power and to provide the harvested solar power to the battery.

13. The sensor system of claim 1, wherein the wireless transmitter is structured to use a wireless communication protocol selected from Bluetooth, Wi-Fi, and Z-Wave.

14. The sensor system of claim 1, wherein the wireless signal is configured to carry information.

15. The sensor system of claim 14, wherein the wireless signal is configured to carry temperature information.
